(19) United States
(12) Patent Application Publication
(10) Pub. No.: US 2010/0283734 A1
(43) Pub. Date: Nov. 11, 2010

(54) PRESENTATION SYSTEM

(76) Inventors: Mark Hallbauer, Dresden (DE); Holm Hallbauer, Dresden (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/664,238

(22) PCT Filed: Apr. 1, 2008
(86) PCT No.: PCT/EP2008/002596

§ 371 Date: May 14, 2010

(30) Foreign Application Priority Data
Jun. 14, 2007 (DE) 102007028011.6
Sep. 19, 2007 (EP) 07018430.4
Sep. 19, 2007 (EP) 07018431.2

(51) Int. Cl. G09G 5/00

(52) U.S. Cl. 345/168; 345/156; 345/173

(57) ABSTRACT

The present invention relates to a presentation system (100, 200), especially for use as an electronic selling aid for advertisements, for example in print media, or for insurance policies, wherein the presentation system (100, 200) has a base module (20) having a base module monitor (21) for showing a presentation intended for a customer and a control module (30) for controlling the base module (20) having the base module monitor (21) in dependence on commands and/or data input into the presentation system (100, 200). In order to ensure that it is possible, on the one hand, to impart to the client or customer in a short time, in a manner that is as efficient as possible, an overview of the advantageousness and usefulness of the offered services or goods for his enterprise and, on the other hand, to draw up during the discussion with the customer a solution that is optimally adapted to the customer and to explain it in very clear manner to the customer during the customer discussion itself, the presentation system (100, 200) has an operating module (10) having an associated operating module monitor (11) for showing first information content, especially for showing information intended for a salesperson, and for showing data for controlling the course of a presentation shown on a base module monitor (21), and an inputting interface (12) electronically and/or electrically coupled to the operating module (10), by means of which data is inputtable, especially in dependence on the information content shown on the operating module monitor (11).

The present invention relates to a presentation system, especially for use as an electronic selling aid for advertisements, for example in print media, or for insurance policies, the presentation system having a base module having a base module monitor for showing a presentation intended for a customer and a control module for controlling the base module having the base module monitor in dependence on commands and/or data input into the presentation system.

When making sales proposals for services and goods, especially proposals for advertisements in print media, on the internet or the like, or proposals for insurance policies etc., it is necessary for the service-provider or salesperson to present his proposal to the customer in question in an, as far as possible, optimally adapted form. In a presentation of such a kind, it is frequently desirable not just to convince the (potential) customer about a proposal but also to find a solution that is, as far as possible, optimised for the customer. For this purpose it is usually necessary that the solution is not drawn up in its definitive form until during the discussion with the customer. This efficiently ensures that, in the end, a tailor-made proposal can be submitted to the customer.

However, when drawing up a customer-specific solution during the discussion with the customer, it has to be ensured that, on the one hand, the customer data required by the service-provider or salesperson is available in transparent form to the service-provider and customer and that, on the other hand, a proposal that is specific to the customer is drawn up in a manner that is clear and that can be followed by the customer. It is frequently necessary during such a customer discussion first to convince the customer of the fact that, for example, a service being newly offered does indeed hold promise of economic success.

On the other hand, it has to be considered that, in the customer discussion, the salesperson or service-provider will have only a limited time available in each case in order to impart his concept to the customer. It is accordingly necessary for this concept to be put across to the customer in an, as far as possible, optimum manner in a short time.

In order to be able to specifically adapt a service to a particular customer, customer-specific data such as, for example, the level of sales of the customer, the market share of the customer, the number of employees of the customer etc. is required. This information is usually available, in the form of card-index cards, to the salesperson before the customer discussion. However, it is often not certain, as far as the salesperson is concerned, that this data is up to date. Therefore, at the start of each sales discussion, the data of the customer is usually discussed with the customer. In order for there to be transparency between the salesperson and the customer, it would then be necessary, for example, for the customer data to be presented on a printed-out sheet of paper.

It is furthermore necessary, at the start of the discussion, to briefly inform the customer about the advantages of the service or goods being offered by the salesperson. For this purpose, hand-outs or similar information sheets are customarily used, which are presented and subsequently handed to the customer. Often in a discussion with a customer the salesperson furthermore presents a proposal (already more or less adapted to the customer), in which the service proposed by the salesperson has already been incorporated. Such a proposal is often also prepared by the salesperson in the form of a hand-out and is handed to the customer during the customer discussion. On the basis of such a proposal, the actual customer-matched solution is usually then jointly drawn up during the sales discussion.

Accordingly, several different hand-outs are usually used as selling aids, in which the advantages of the service offered or of the goods offered are presented during a sales discussion. Moreover, a further additional hand-out is frequently used, by means of which a proposal is submitted to the customer, already incorporating the offered service or goods. Furthermore there is often provided a third hand-out, in which the actual customer-specific solution is drawn up together with the customer during the customer discussion. In all, therefore, a large number of hand-outs, information sheets etc. have hitherto been necessary, which the salesperson and the customer have to discuss during such a sales discussion.

The disadvantage of that customary solution is to be seen especially in the fact that, in the course of the sales discussion, the customer or client frequently loses their overview of the usefulness and advantageousness of the offered service or goods. This means, in other words, that the salesperson can no longer effectively present his service or goods. Likewise, an important part is played by the just limited time generally available during a sales discussion. Within this time it is necessary for the salesperson to present the advantages of his goods or service to the customer in as transparent a manner as possible and, at the same time, to prepare a solution that is, as far as possible, optimal for the customer.

In respect of the drawing up, during the customer discussion, of a solution that is best matched to the customer, it should finally be pointed out that this customer-specific solution frequently cannot be drawn up until during the customer discussion because the actual requirements of the customer generally do not become apparent to the salesperson until during the course of the customer discussion.

It is true that, for such customer discussions, laptop computers are also already being used occasionally in order to simplify the drawing up of a customer-specific solution during the customer discussion. However, it is not possible, using laptop computers, to present to the (potential) customer clearly, in a “manner that is pleasant” for the customer, the advantages and scope of the service or goods offered by the salesperson. This is due to the fact that any laptop computer is in the form of a “one-man work station” and therefore is suitable to an only limited extent, if at all, as a presentation aid in a customer discussion. In particular, a laptop computer used as a presentation aid prevents almost all eye contact between the salesperson and the (potential) customer. This results in the fact that, when using a laptop computer as a presentation aid in a customer discussion, the direct contact between the salesperson and the potential customer is lost or cannot even be established in the first place. This set of problems has been known for a long time. For this reason, it has not hitherto been possible for use of a laptop computer as a presentation system to become established practice in customer discussions.

Starting from the above-described requirements for a customer discussion that is, as far as possible, optimal, the present invention is based then on the problem of providing a presentation system for use as an electronic selling aid of the kind mentioned at the beginning, by means of which, in a “manner that is pleasant” for the customer, it is possible, on the one hand, in as efficient a manner as possible, to impart to the client or customer, in a short time, an overview of the advantageousness and usefulness of the offered services or goods for his enterprise and, on the other hand, to draw up during the customer discussion, in transparent manner, a solution that is optimally matched to the customer and to explain it to the customer during the customer discussion itself.

The problem is solved, in accordance with the invention, by a presentation system which has the following:
an operating module having an associated operating module monitor for showing first information content, especially for showing information intended for a salesperson, and for showing data for controlling the course of a presentation shown on a base module monitor;
an inputting interface electronically and/or electrically coupled to the operating module, by means of which data is inputtable, especially in dependence on the information content shown on the operating module monitor;
electrically connected or connectible to the operating module, a base module having the base module monitor for showing second information content such as, for example, a presentation intended for a customer;
a control module which is arranged to individually control each of the operating module monitor and the base module monitor in dependence on a presentation loaded on the presentation system and/or the data input by way of the inputting interface.

The advantages obtainable with the solution according to the invention—especially when used as an electronic selling aid for advertisements in print media etc.—are very clear. On the one hand, the proposed solution provides a presentation system which makes it possible, by virtue of its construction as an electronic system, to dispense with all hand-outs, information sheets etc.. On the other hand, the solution according to the invention makes it possible for the customer data updated during a customer discussion to be input directly into the presentation system by way of the inputting interface and for it to be included in the presentation to be shown to the customer during the customer discussion. This updated customer data is accordingly included in the presentation or the course of the presentation, which substantially simplifies the possible subsequent further processing of that data.

The presentation system especially has a control module, by means of which a presentation is played on the base module monitor, the control module preferably being arranged to generate individualised solutions or parts thereof during the customer discussion and to present them, at least in part, to the customer.

In particular, arrangements are made in accordance with the invention for the base module monitor, which, as the main screen, serves to show the customer the sales presentation, to be integrated in the base module, whilst the operating module monitor having the inputting interface is contained in the operating module. Because the salesperson usually sits opposite the customer in a customer discussion, it is possible, with the arrangement of the presentation system according to the invention, for the presentation system to be so constructed that the base module having the base module monitor is in front of the customer while the operating module having the operating module monitor and the inputting interface is in front of the salesperson. This ensures that the sales presentation can be made in a manner that is pleasant for the customer whilst, on the one hand, the customer can optimally view the base module monitor and, on the other hand, the eye-contact between the customer and the salesperson is not interrupted, for example by a laptop monitor standing up vertically.

The operating module monitor, which is integrated in the operating module, which faces the salesperson during the sales discussion, serves for showing information intended for the salesperson, especially customer-specific data, and data for controlling the course of the presentation shown on the base module monitor. Accordingly, the displays shown on the two monitors of the presentation system are usually different from one another. Especially as a result of the fact that, on the one hand, the data and information that is relevant for the salesperson is shown on the operating module monitor, whereas, on the other hand, the presentation intended for the customer, that is to say the data and information that is relevant for the customer, is shown on the (main) base module monitor, it is possible for the presentation to be made very clear for the (potential) customer. The displays on the respective monitors are, especially, independent of one another. It is accordingly ensured that, during the sales discussion, the (potential) customer is confronted only with that data and information which is actually intended for him. As a result, especially, overwhelming the customer with data and information that is not relevant to him is avoided.

On the other hand, the presentation system and, in particular, the control module provided in the presentation system should be arranged to individually control the base module monitor and the operating module monitor of the presentation system in dependence on a presentation loaded on the presentation system and/or commands or data input by way of the inputting interface. This feature makes it possible for a customer-optimised presentation to be playable on the presentation system. For example, it is feasible for the presentation shown on the presentation system to be used as an aid for the selling of advertisements. The latter usually have a very particular geometric shape, which is individually filled with textual content. Relevant data in regard of a target person, that is to say information compiled for a very specific contact person at a potential customer's, can then be input by the salesperson by way of the inputting interface of the control module during the sales discussion.

As already indicated, the presentation running on the presentation system according to the invention preferably comprises software which describes a method of generating an individualised customer proposal. In this method, preferably, the customer-relevant data input during the sales discussion by way of the inputting interface is analysed preferably using machine learning. The expression “machine learning” is to be understood herein as especially a self-optimisation process which, on the basis of automatic changes in evaluation criteria etc., produces an improved result on each new run-through. The result is all the better if a greater probability of closing a deal in advertisement selling is achieved.

The advantage of the presentation system according to the invention accordingly lies in the fact that, during the sales discussion, a large amount of individualised customer data can be collected and input into the control module by the salesperson by way of the inputting interface of the presentation system, with evaluation of that individualised customer data being carried out with the aid of the presentation software running on the presentation system so that for different (potential) customers, in real time, that is to say during the sales discussion, an individualised proposal can be produced, incorporated into the presentation that is to be shown to the customer, and shown on the base module monitor of the presentation system.

It is, especially, feasible that, during assessment of the individualised customer data input by way of the inputting interface of the presentation system, inter alia, a number of prototype classes of so-called customer models are also formed, these customer models representing idealised customer types which have emerged in the classical sales process. The advantage of prototype classes formed using a classifying algorithm lies in the fact that a large number of individualised customers can be mapped onto these prototype customer classes so that although further processing of the information on an individual basis with respect to an individual customer is possible it is still possible to carry out abstract further processing on the basis of the properties of the classes. More abstract further processing in this context means that a whole group of customers can be treated in the same way, for example by means of identical control parameters being input in the next step of the method. This can mean, inter alia, the use of identical customer solutions drawn up during the customer discussion. In the process, the advantages both of purely individualised treatment and also of purely class-based treatment of customer groups are combined with one another.

Preferably, the information content presented to the customer on the base module monitor consists not of a sequence of standard presentation pages but rather of a tailored sequence of presentation pages which are so arranged that they guide the customer through the sales discussion in structured manner. In the process, information that is directed only to the salesperson is shown on the operating module monitor in such a way that only he can read it, because it will be seen, for example, by the discussion counterpart (customer) as being “upside-down”, whereas the information that is relevant for the customer will be shown on the base module monitor of the presentation system so that it can be easily read by the potential customer and—when the customer and salesperson are sitting directly opposite one another in the customer discussion—will be seen by the salesperson as being “upside-down”.

Preferably, the data shown on the operating module monitor of the presentation system and serving for controlling the course of the presentation shown on the base module monitor comprises a sequence of presentation pages which can be selected by the salesperson during the sales discussion and displayed on the first monitor.

If the customer and the salesperson are sitting opposite one another in the sales discussion it is desirable for the clear view between the salesperson and the customer not to be impeded. For this reason, in the presentation system according to the invention, the operating module and the base module are rotated through 180° relative to one another. Accordingly, the operating module and the base module can be so arranged for the customer discussion that no vertically, or almost vertically, extending display device etc. stands between the customer and the salesperson and accordingly impedes the clear view. In an especially preferred arrangement of the presentation system provision is preferably made for the control module provided in the presentation system to automatically adjust the orientation of the presentation shown on the base module monitor in dependence on the arrangement of the operating module and the base module relative to one another.

By means of this preferred development of the presentation system according to the invention it is accordingly possible, on the one hand, to operate the presentation system in a first mode, in which the salesperson sits opposite the (potential) customer and the base module monitor of the presentation system is oriented towards the customer whilst the information and data displayed on the operating module monitor is oriented towards the salesperson. In this mode, the presentation shown on the base module monitor is then oriented in a direction opposite to the orientation of the information and data shown on the operating module monitor. On the other hand, in a second mode, preference is given to the presentation shown on the base module monitor being oriented in the same direction as the information and data shown on the operating module monitor. The presentation system can then be used also for customer discussions in which the customer and salesperson are not sitting opposite one another but rather, for example, are standing next to one another in front of the presentation system.

In order to ensure that the control module of the presentation system “automatically” sets the correct orientation of the presentation to be displayed on the base module monitor, it is—if the operating module is tiltably connected to the base module by way of a hinge connection—feasible, for example, to integrate an appropriate sensor in the hinge connecting the operating module and the base module, which sensor registers the degree of folding-out of the operating module and delivers corresponding signals to the control module in dependence on the angle of folding-out of the operating module.

As already explained, preference is given to presentation software which can be influenced by the commands and/or data input from the inputting interface running on the presentation system according to the invention. In a preferred arrangement of this embodiment, the control module has, for the purpose, a storage means for storing data for customer-specific presentations and for storing data input by way of the inputting interface, and also a processor for processing data input by way of the inputting interface and for modifying the presentation to be shown on the base module monitor in dependence on data or commands input by way of the inputting interface.

It is, in principle, advantageous, if the control module of the presentation system according to the invention further has a preferably wireless communications interface, especially a mobile telephone interface, IR interface or Bluetooth interface, in order to make data communications possible with external devices. Of course, however, the communications interface can also be wired, such as, for example, an interface for a PDA device, or an interface for a USB stick. By means of this additional communications interface it is possible to transfer into the control module the presentation to be shown using the presentation system. On the other hand, an interface of such a kind for an external device is also suitable for the purpose of downloading from the presentation system, after the sales discussion, the solution specifically drawn up for the customer in order to be able to further process it or to store it externally.

In an especially preferred embodiment of the presentation system according to the invention, the operating module monitor, on which there is shown the information intended for the salesperson and also the data for controlling the course of the presentation shown on the base module monitor, is in the form of a touch screen monitor, with the inputting interface of the presentation system being integrated, in the form of a touch screen field, in this operating module monitor in the form of a touch screen monitor. In this case it would furthermore be feasible for the presentation system to be provided with the functionality of text recognition so that the inputting of information can be carried out with the aid of a touch screen stylus pen by way of the inputting interface. Of course, however, it is also feasible for the base module monitor serving for showing the presentation intended for the customer to be in the form of a touch screen monitor.

In order to simplify the inputting of data by way of the inputting interface of the presentation system, especially when the data comprises lengthy text fields etc., provision can preferably be made for the inputting interface to additionally have a keyboard connected or connectible to the control module. By means of this development the functionality of the presentation system is correspondingly extended so that—for example, after a customer discussion—it can also be used as a kind of laptop computer.

In order to ensure that, during a sales discussion, the (potential) customer can watch the sales presentation shown on the base module monitor with optimum image quality independently of the viewing location, preference is given to at least the base module monitor being in the form of a display screen without a particular preferential viewing direction. This preferred development accordingly prevents colour distortions etc. coming about in dependence on the location of the viewer (customer). In particular, brightness, colour and contrast exhibit changes if a screen without a particular preferential viewing direction is not used as the base module monitor and the predetermined viewing angle is not maintained. Accordingly, preference is given to using, as the base module monitor, a screen based on plasma technology or an LC display of class I (according to ISO standard 13406-2). Of course, however, other screens which do not have a particular preferential viewing direction also come into consideration.

In order to allow operational redundancy of the presentation system, the latter should further have an internal power supply, for example in the form of preferably rechargeable batteries and/or a fuel cell. When rechargeable batteries are used as an internal power supply, it is accordingly feasible in a preferred arrangement of the presentation system for the mains unit or charging device required for charging those rechargeable batteries to be provided externally to the presentation system in order, on the one hand, to prevent heat being unnecessarily generated in the interior of the presentation system during the charging period and, on the other hand, to ensure that the overall size of the presentation system is as small as possible. In this context special preference is given to the rechargeable batteries being chargeable by means of, for example, a car battery in order to meet requirements in field sales.

Preferably, the base module monitor, which serves for showing the sales presentation to the customer, should be of a size matched to the size of the installation space maximally made available by the base module in order to be able to ensure as large an area as possible for the presentation. This requirement is not absolutely necessary for the operating module monitor. In order, nevertheless, for the operating module to be constructed in a form that is as small and compact as possible, the operating module monitor should preferably likewise be of a size matched to the operating module.

In a preferred arrangement of the presentation system according to the invention, a slide-in compartment is formed in the base module, which serves to accommodate the operating module together with the associated operating module monitor. In this context, the operating module together with the associated operating module monitor should be in the form of a unit which can be slid into the slide-in compartment of the base module. Preference is further given to the operating module together with the associated operating module monitor being slidable in and out from a first position, in which the operating module together with the associated operating module monitor has been pulled out from the slide-in compartment to in front of the base module, to a second position, in which the operating module together with the associated operating module monitor has been slid into the slide-in compartment of the base module.

In a preferred development of the last-mentioned embodiment of the presentation system, provision is further made for the operating module together with the associated operating module monitor to be tiltable in the first position relative to the base module.

On the other hand, it would also be feasible for the operating module together with the associated operating module monitor to be connected to the base module by way of a hinge connection and to be arranged to be foldable in and out by means of the hinge connection from a first position, in which the operating module together with the associated operating module monitor has been folded out in front of the base module, into a second position, in which the operating module together with the associated operating module monitor has been folded into the base module.

It is especially advantageous if, in the case of the presentation system according to the two last-mentioned preferred arrangements, the base module has a parallelepipedal outer contour, more specifically at least when the operating module together with the associated operating module monitor is in the second position. In that case, on the rear face of the base module, both on the side adjacent to the operating module and also on the correspondingly opposite side, there is preferably provided in each case at least one foot which can be folded out, with the at least one foot provided on the rear face of the base module on the side adjacent to the operating module being shorter than the at least one foot provided on the correspondingly opposite side.

In the last-mentioned arrangement of the presentation system, the control module should be arranged to orient the second information content shown on the base module monitor differently by 180° in dependence on whether the at least one foot provided on the side adjacent to the operating module or the at least one foot provided on the correspondingly opposite side is folded out.

In another embodiment of the presentation system according to the invention, provision is made for the base module for showing the second information content further to have a second base module monitor, which is in articulated connection with the base module monitor at a side edge and which is arranged to be foldable over from a closed state, in which the second base module monitor lies on the base module monitor, to an open state, in which the second base module monitor lies adjacent to the base module monitor beside the base module monitor.

In another arrangement of the presentation system according to the invention, provision is made for the base module for showing the second information content further to have at least two second base module monitors, each of which is in articulated connection with the base module monitor at a side edge and is arranged to be foldable over from a closed state, in which the two second base module monitors lie on top of one another or next to one another on the base module monitor, to an open state, in which the two second base module monitors lie in each case adjacent to the base module monitor beside the base module monitor.

Preferred embodiments of the presentation system according to the invention are described hereinbelow with reference to the accompanying drawings, in which:

FIGS. 1a-d are a rear view, front view, side view and perspective view from above of a first embodiment of the presentation system according to the invention occupying its first state;

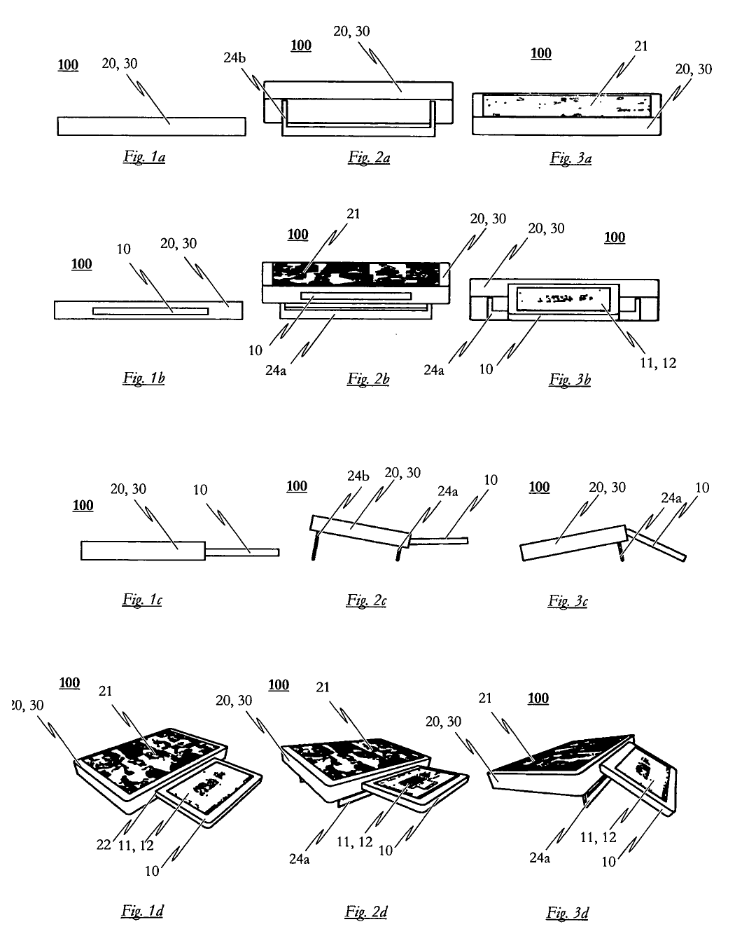

FIGS. 2a-d are a rear view, front view, side view and perspective view from above of the presentation system according to the first embodiment of the invention occupying its second state;

FIGS. 3a-d are a rear view, front view, side view and perspective view from above of the presentation system according to the first embodiment of the invention occupying its third state;

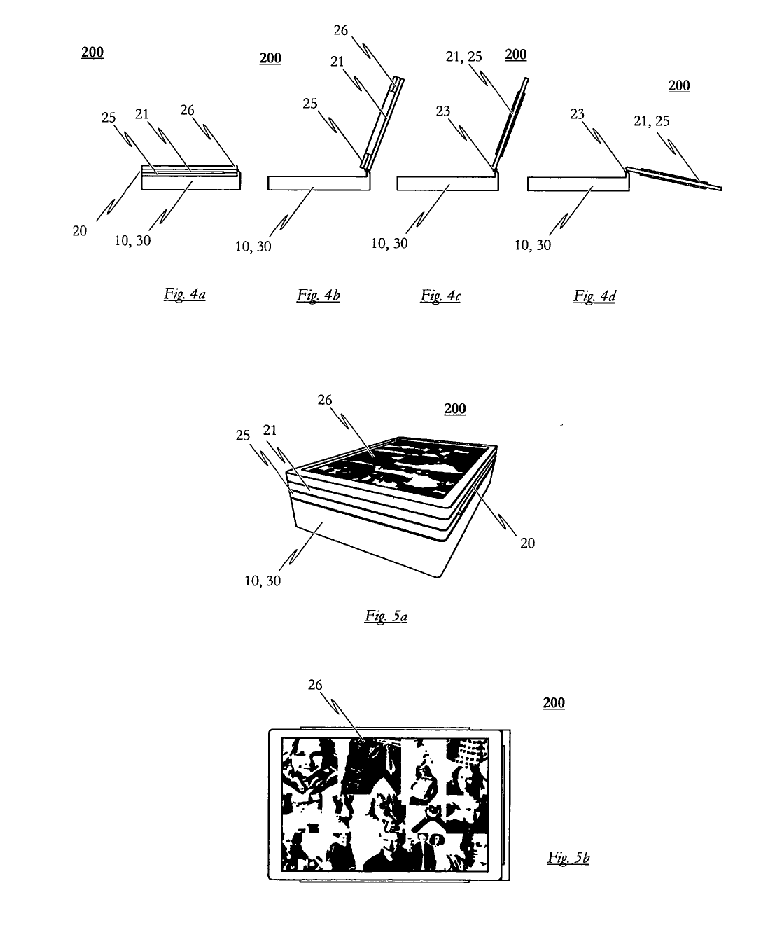

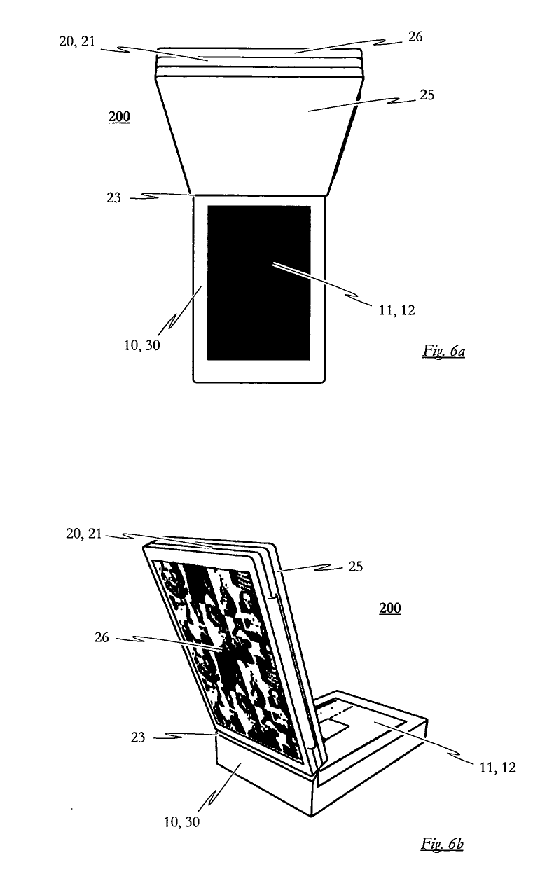

FIGS. 4a-d are in each case a side view of a presentation system according to a second embodiment of the present invention, more specifically in the closed state, in the half-opened state with a second base monitor that has not been folded out, in the half-opened state with a second base monitor that has been folded out, and in the fully folded-out state;

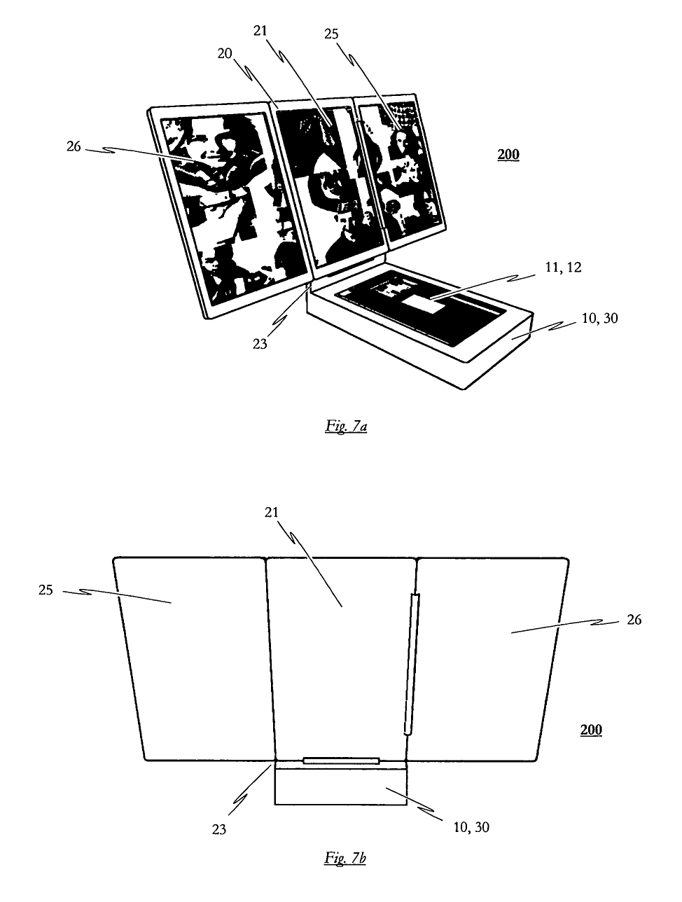

FIGS. 5a, b are a perspective view from above and a top view of the presentation system according to the second embodiment of the present invention, which is in its closed state;

FIGS. 6a, b are a top view and a perspective view from the rear of the presentation system according to the second embodiment of the present invention, which is in the half-opened state, the second base monitors not having been folded out;

FIGS. 7a, b are a perspective view from the front and a rear view of the presentation system according to the second embodiment of the present invention, which is in the half-opened state, the second base monitors having been folded out; and

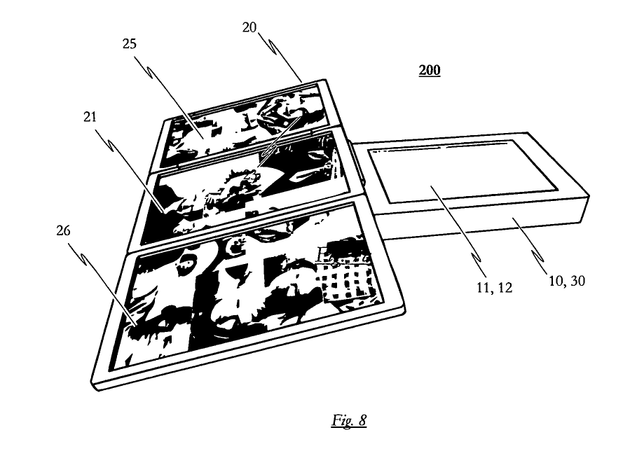

FIG. 8 is a perspective view, from the side, of the presentation system according to the second embodiment of the present invention, which is in the fully folded-out state;

There will be described hereinbelow with reference to FIGS. 1 to 3 a first preferred embodiment of the presentation system 100 according to the invention. In this context there are shown in FIGS. 1a to 1d a rear view, a front view, a side view and a perspective view from above of the presentation system 100, the presentation system 100 being in its first state in these illustrations, in which the operating module 10 and the base module 200 connected to that operating module 10 are lying flat next to one another on a support surface (not explicitly shown). A rear view, a front view, a side view and a perspective view from above of the presentation system 100 according to the first embodiment of the present invention is likewise shown in FIGS. 2a to 2d and in FIGS. 3a to 3d; however, the illustrations in FIGS. 2a to 2d each show the presentation system 100 in its second state, in which both the operating module 10 and the base module 20 are each slightly inclined in one direction. The illustrations in FIGS. 3a to 3d show the presentation system 100 in its third state, in which the operating module 10 is inclined in the direction of one side and the base module 20 is inclined in the direction of the other side.

As shown, the presentation system 100 according to the first preferred embodiment basically has the following components: the already mentioned operating module 10, in which an operating module monitor 11 is integrated; an inputting interface 12 electronically coupled to the operating module 10; a base module 20 which is electrically connected to the operating module 10 and in which a base module monitor 21 is integrated; and a control module (not explicitly shown) which in the first preferred embodiment of the present invention is integrated in the base module 20. The operating module monitor 11 of the operating module 10 serves for showing first information content, especially for showing information intended for a salesperson, and for showing data for controlling the course of a presentation shown on the base module monitor 21. By way of the inputting interface 12, which is electronically coupled to the operating module 10, it is possible to input data (commands, information etc.) in dependence on the information content shown on the operating module monitor 11. The base module monitor 21, which is integrated in the base module 20, serves for showing second information content such as, for example, a presentation intended for a customer. The control module integrated in the base module 20 is arranged to individually control each of the operating module monitor 11 and the base module monitor 21 in dependence on a presentation loaded on the presentation system 100 and/or in dependence on data input by way of the inputting interface 12.

The embodiment, shown in FIGS. 1 to 3, of the presentation system 100 according to the invention is especially distinguished by the fact that a slide-in compartment 22 is constructed in the base module 20, which compartment serves to accommodate, when required, the operating module 10 together with the associated operating module monitor 11. In this arrangement, the operating module 10 together with the associated operating module monitor 11 is in the form of a unit which can be slid into the slide-in compartment 22 of the base module 20 and is arranged to be slidable in and out from a first position, in which the operating module 10 together with the associated operating module monitor 11 has been pulled out from the slide-in compartment 22 to in front of the base module 20, into a second position, in which the operating module 10 together with the associated operating module monitor 11 has been slid into the slide-in compartment 22 of the base module 20. The illustrations in FIGS. 1 to 3 each show the operating module 10 in its first position.

It can be seen especially from the illustrations in FIGS. 2 and 3 that the operating module 10 together with the integrated operating module monitor 11 is, in its first position, tiltable relative to the base module 20. For this purpose, a suitable hinge connection 23 is provided at the edge between the operating module 10 and the base module 20. Of course, however, it would also be feasible, instead of providing a slide-in compartment 22, for the operating module 10 together with the integrated operating module monitor 11 to be connected to the base module 20 by way of a separate hinge connection and to be arranged to be foldable in and out by means of this separate hinge connection from a first position, in which the operating module 10 together with the associated operating module monitor 11 has been folded out in front of the base module 20, into a second position, in which the operating module 10 together with the associated operating module monitor 11 has been folded into the base module 20.

It is in principle the case that the presentation system 100 according to the first embodiment of the present invention should have a parallelepipedal outer contour when the operating module 10 together with the associated operating module monitor 11 is in the second position, that is to say either slid into the slide-in compartment 22 or folded into the base module 20.

It can be seen especially from the illustrations in FIGS. 2c and 3c that on the rear face of the base module 20, both on the side adjacent to the operating module 10 and also on the correspondingly opposite side, there is provided in each case at least one foot 24 which can be folded out, with the at least one foot 24a provided on the rear face of the base module 20 on the side adjacent to the operating module 10 being shorter than the at least one foot 24b provided on the correspondingly opposite side.

The individual feet 24a, 24b on the rear face of the base module 20 are capable of being sunk into corresponding recesses in the rear face of the base module 20 when they are not folded out. In each of FIGS. 1a to 1d, the presentation system 100 according to the first preferred embodiment is shown in a state (first state), in which the two feet 24a, 24b are sunk into the respective recesses (not explicitly shown) in the rear face of the base module 20. In that first state, the operating module 10 and the base module 20 accordingly lie next to one another virtually in one plane.

If the presentation system 100 is to be operated only from one side, especially only from the side on which the operating module 10 is arranged, the second state, shown in FIGS. 2a to 2d, is especially suitable, in which the two feet 24a and 24b are each folded out and accordingly form an appropriate inclined support primarily for the base module 20. Because the operating module 10 is in articulated connection with the base module 20, the operating module 10 also has a certain inclination when the presentation system 100 is in the second state, with both the inclination of the operating module 10 and also that of the base module 20 facing in the same direction.

When the presentation system 100 is to be used for a presentation in which two people are sitting opposite one another, the third state, shown in FIGS. 3a to 3d, is preferred, in which only the foot 24a is folded out, so that the operating module 10 together with the associated operating module monitor 11 is facing in the direction of the first person (salesperson) and the base module 20 together with the associated base module monitor 21 is facing the second person (client).

Preferably, the presentation system 100 is arranged to automatically select the orientation of the respective images on the operating module monitor 11 and the base module monitor 21 in dependence on the state occupied by the presentation system 100. In particular, the images on those two monitors 11 and 21 should have opposite orientations in the third state (compare FIGS. 3a to 3d). In a preferred arrangement, it is feasible that appropriate sensors be arranged at the two feet 24a, 24b, with the aid of which the particular state of the presentation system 100 is registered and accordingly the orientation of the images on the monitors 11, 21 is selected.

The first embodiment of the presentation system 100 according to the invention is not limited to the illustrations of FIGS. 1 to 3. It would especially also be feasible, for example, for the operating module 10 to be constructed individually and separately from the base module 20, with its being possible for these two modules to communicate with one another by way of a cable-free interface.

There will be described hereinbelow, with reference to FIGS. 4 to 8, a second preferred embodiment of the presentation system according to the invention. In this case, the illustrations of FIGS. 4a to 4d each show a side view of the presentation system 200 according to the second preferred embodiment of the present invention, more particularly a) in a state in which the presentation system 200 is fully closed; b) in a state in which the base module 20 is tilted relative to the operating module, about the hinge, so that the presentation system 200 is in a half-opened state; c) in a half-opened state of the presentation system 200, in which the second base module monitors (to be described hereinbelow) have been folded out; and d) in a state in which the presentation system 200 is in its fully folded-out state.

FIGS. 5a and 5b show the presentation system 200 according to the second embodiment in its fully closed state (cf. FIG. 4a), more particularly in a perspective view from the side (FIG. 5a) and in a top view from above (FIG. 5b). FIGS. 6a and 6b show the presentation system 200 in its half-opened state in which the second base module monitors have not been folded out, more particularly in a top view from above (FIG. 6a) and in a perspective view from the rear (cf. FIG. 6b). In FIGS. 7a and 7b, the presentation system 200 is shown in its half folded-out state in which the second base module monitors have been folded out, with FIG. 7a being a perspective view from the front and FIG. 7b being a rear view. FIG. 8 is a perspective view, from the side, of the presentation system 200, which is in its fully folded-out state.

As shown, the presentation system 200 according to the second embodiment has the operating module 10 with the operating module monitor 11 integrated into it. As also in the case of the first embodiment of the presentation system according to the invention, the operating module 10 is furthermore provided with an inputting interface, which in the case of the shown embodiment is in the form of touch screen operating fields which are integrated in the operating module monitor 11.

In the case of the presentation system 200 according to the second embodiment—in contrast to the presentation system 100 according to the first embodiment—the control module 30 is integrated in the operating module 10. The base module 20 together with the base module monitor 21 is in tiltable articulated connection with the operating module 10 by way of the hinge connection 23.

It is characteristic of the second embodiment of the presentation system 200 according to the invention that the base module 20 for showing the second information content further has a first second base module monitor 25 and a second second base module monitor 26. The two second base module monitors 25, 26 are in each case in articulated connection with a side of the base module monitor 21 by way of, in each case, a hinge connection. In particular, the first second base module monitor 25 is in articulated connection with the base module monitor 21 at a first side edge of the base module monitor 21 and is arranged to be foldable over from a closed state, in which the first second base module monitor 25 lies on the base module monitor 21 (cf., for example, the illustration in FIG. 6a), to an open state, in which the first second base module monitor 25 lies adjacent to the base module monitor 21 beside the base module monitor 21 (cf., for example, the illustrations in FIGS. 7a and 8).

For showing the second information content there is further provided the second second base module monitor 26, which is in articulated connection with the base module monitor 21 at a second side edge of the base module monitor 21 and is arranged to be foldable over from a closed state, in which the two second base module monitors 25 and 26 lie on top of one another on the base module monitor 21 (cf., for example, the illustration in FIG. 6a), to an open state, in which the two second base module monitors 25, 26 each lie adjacent to the base module monitor 21 beside the base module monitor 21 (cf, for example, the illustrations in FIGS. 7a and 8).

From the illustrations in FIGS. 5a and 6b it can especially be seen that the second second base module monitor 26 is in articulated connection with the second side edge of the base module monitor 21 in such a way that, in the closed state of the presentation system 200, that is to say when the two second base module monitors 25, 26 are lying on the base module monitor 21, the second second base module monitor 26 faces upwards.

As already indicated with reference to the illustrations in FIGS. 4a to 4d, the base module monitor 21 is connected to the operating module 10 by way of an articulated connection 23 and is arranged to be changeable from a first state, in which the base module monitor 21 lies on the operating module 10 and the operating module monitor 11 integrated in the operating module 10 (cf. the illustration in FIG. 4a), to a second state, in which the base module monitor 21 is half folded out (cf. the illustrations in FIGS. 4b and 4c), and into a third state, in which the base module monitor 21 is fully folded out (cf. the illustration in FIG. 4d). In that case, preference is given to the images on the base module monitor 21 and the associated second base module monitors 25 and 26 and the image on the operating module monitor 11 having the same orientation when the presentation system is in the second state (cf. the illustrations in FIGS. 4b and 4c). When the presentation system 200 is in the third state (cf. the illustration in FIG. 4d), in contrast, the images on the base module monitor 21 and the associated second base module monitors 25 and 26 and the images on the operating module monitor 11 should have an orientation that is different by 180°.

In principle it is the case for both embodiments of the presentation system 100, 200 according to the invention that the base module monitor 21 and the associated second base module monitors 25, 26 should have a viewing angle dependency which is as low as possible in order to ensure that the customer is always provided with an optimum image on the base module monitor 21 from different viewing angles.

Compared to the base module monitor 21, the operating module monitor 11 is usually of substantially smaller construction because it does not primarily have a presentation function but rather serves for controlling the course of the presentation shown on the base module monitor 21 (and also on the optionally provided second base module monitors 25, 26).

Special preference is given to at least the operating module monitor 11 being in the form of a touch screen monitor so that commands and data, especially for controlling the course of the presentation shown on the base module monitor 21, can be input into the presentation system 100, 200 by way of suitable touch screen fields. Accordingly, in the case of the presentation systems 100 and 200 shown in the drawings, the touch screen fields of the operating module monitor 11 serve as the inputting interface 12 for the presentation system 100, 200.

In addition to those inputting interfaces 12, it is further feasible for the presentation system 100, 200 to have an additional keyboard connectible to the presentation system 100, 200.

Although it cannot be seen explicitly from the drawings shown, the control module 30 further includes, preferably, a storage means for storing presentations which are to be displayed on the base module monitor 21 (and optionally on the provided second base module monitors 25, 26). The storage means preferably serves also for storing data which is or has been input into the presentation system 100, 200 by way of the inputting interface 12. In addition thereto, preference is given to the control module 30 further having a processor in order to be able to process the data input by way of the inputting interface 12 and in order to modify the presentation to be shown on the base module monitor 21 in dependence on, for example, data or commands input by way of the inputting interface 12, preferably during a sales discussion.

The control module 30 should further have a preferably wireless communications interface such as, for example, a mobile telephone interface, IR interface or Bluetooth interface in order to make data communications possible with external devices.

What is claimed is:

1. Presentation system (100, 200), especially for use as an electronic selling aid for advertisements in print media, on the interne or the like, the presentation system (100, 200) having the following:
an operating module (10) having an associated operating module monitor (11) for showing first information content, especially for showing information intended for a salesperson, and for showing data for controlling the course of a presentation shown on a base module monitor (21);
an inputting interface (12) electronically and/or electrically coupled to the operating module (10), by means of which data is inputtable, especially in dependence on the information content shown on the operating module monitor (11);
electrically connected or connectible to the operating module (10), a base module (20) having the base module monitor (21) for showing second information content such as, for example, a presentation intended for a customer; and
a control module (30) which is arranged to individually control each of the operating module monitor (11) and the base module monitor (21) in dependence on a presentation loaded on the presentation system (100, 200) and/or the data input by way of the inputting interface (12).

2. Presentation system (100) according to claim 1,
wherein the control system (30) is integrated in the base module (20).

3. Presentation system (100) according to claim 1,
wherein a slide-in compartment (22) is formed in the base module (20) for accommodating the operating module (10) together with the associated operating module monitor (11), and wherein the operating module (10) together with the associated operating module monitor (11) is in the form of a unit which can be slid into the slide-in compartment (22) of the base module (20) and is arranged to be slidable in and out from a first position, in which the operating module (10) together with the associated operating module monitor (11) has been pulled out from the slide-in compartment (22) to in front of the base module (20), to a second position, in which the operating module (10) together with the associated operating module monitor (11) has been slid into the slide-in compartment (22) of the base module (20).

4. Presentation system (100) according to claim 3,
wherein, in the first position, the operating module (10) together with the associated operating module monitor (11) is tiltable relative to the base module (20).

5. Presentation system (100) according to claim 1,
wherein the operating module (10) together with the associated operating module monitor (11) is connected to the base module (20) by way of a hinge connection (23) and is arranged to be foldable in and out by means of the hinge connection (23) from a first position, in which the operating module (10) together with the associated operating module monitor (11) has been folded out in front of the base module (20), into a second position, in which the operating module (10) together with the associated operating module monitor (11) has been folded into the base module (20).

6. Presentation system (100, 200) according to claim 5,
wherein the base module (20) has a parallelepipedal outer contour when the operating module (10) together with the associated operating module monitor (11) is in the second position.

7. Presentation system (100) according to claim 6,
wherein, on the rear face of the base module (20), both on the side adjacent to the operating module (10) and also on the correspondingly opposite side, there is provided in each case at least one foot (24) which can be folded out, with the at least one foot (24a) provided on the rear face of the base module (20) on the side adjacent to the operating module (10) being shorter than the at least one foot (24b) provided on the correspondingly opposite side.

8. Presentation system (100) according to claim 7,
wherein the control module is arranged to orient the second information content shown on the base module monitor (21) differently by 180° in dependence on whether the at least one foot (24a) provided on the side adjacent to the operating module (10) or the at least one foot (24b) provided on the correspondingly opposite side is folded out.

9. Presentation system (200) according to claim 1,
wherein the base module (20) for showing the second information content further has a first second base module monitor (25), which is in articulated connection with the base module monitor (21) at a first side edge of the base module monitor (21) and which is arranged to be foldable over from a closed state, in which the first second base module monitor (25) lies on the base module monitor (21), to an open state, in which the second base module monitor (25) lies adjacent to the base module monitor (21) beside the base module monitor (21).

10. Presentation system (200) according to claim 9,
wherein the base module (20) for showing the second information content further has a second second base module monitor (26), which is in articulated connection with the base module monitor (21) at a second side edge of the base module monitor (21) and which is arranged to be foldable over from a closed state, in which the two second base module monitors (25, 26) lie on top of one another on the base module monitor (21), to an open state, in which the two second base module monitors (25, 26) each lie adjacent to the base module monitor (21) beside the base module monitor (21).

11. Presentation system (200) according to claim 10,
wherein the second second base module monitor (26) is in articulated connection with the second side edge of the base module monitor (26) so that, in the closed state of the presentation system (200), when the two second base module monitors (26) are lying on the base module monitor (21), the second second base module monitor faces upwards.

12. Presentation system (200) according to claim 9,
wherein the base module monitor (21) is connected to the operating module (10) by way of an articulated connection and is arranged to be changeable from a first state, in which the base module monitor (21) lies on the operating module (10), to a second state, in which the base module monitor (21) is half folded out, and into a third state, in which the base module monitor (21) is fully folded out.

13. Presentation system (200) according to claim 12,
wherein, in the second state, the image on the base module monitor (21) and the image on the operating module monitor (11) have the same orientation, and wherein, in the third state, the image on the base module monitor (21) and the image on the operating module monitor (11) are differently oriented by 180°.

14. Presentation system (100, 200) according to claim 1,
wherein the control module further has the following:
a storage means for storing presentations and data input by way of the inputting interface (12); and
a processor for processing data input by way of the inputting interface (12) and for modifying the presentation to be shown on the base module monitor (21) in dependence on data or commands input by way of the inputting interface (12).

15. Presentation system (100, 200) according to claim 1,
wherein the control module further has, for data communications with external devices, a wireless communications interface, especially a mobile telephone interface, IR interface or Bluetooth interface.

16. Presentation system (100, 200) according to claim 1,
wherein the operating module monitor (11) is in the form of a touch screen, and wherein the inputting interface (12) is integrated, in the form of a touch screen field, in the operating module monitor (11) in the form of a touch screen.

17. Presentation system (100, 200) according to claim 1,
wherein the inputting interface (12) has a keyboard connected or connectible to the control module.

18. Presentation system (100, 200) according to claim 1,
wherein at least the base module monitor (11) is in the form of a display screen without a particular preferential viewing direction.

19. Presentation system (100, 200) according to claim 1,
which further has an internal power supply in the form of preferably rechargeable batteries and/or a fuel cell.
